(19) United States
(12) Patent Application Publication
(10) Pub. No.: US 2026/0288862 A1
(43) Pub. Date: Sep. 24, 2026

(54) CREATING A LARGE SCALE HEAD-RELATED FILTER DATABASE

(71) Applicant: Telefonaktiebolaget LM Ericsson (publ), Stockholm (SE)

(72) Inventors: Mengqiu ZHANG, Stockholm (SE); Mattias OLOFSSON, Stockholm (SE)

(73) Assignee: Telefonaktiebolaget LM Ericsson (publ), Stockholm (SE)

(21) Appl. No.: 19/475,801

(22) PCT Filed: Apr. 19, 2023
(86) PCT No.: PCT/SE2023/050357

§ 371 Date: Oct. 16, 2025

(51) Int. Cl. G06F 16/635; G06T 19/20; H04S 7/00

(52) U.S. Cl. CPC G06F 16/635; G06T 19/20; H04S 7/304; G06T 2219/2016; G06T 2219/2021; H04S 2400/11; H04S 2420/01

(57) ABSTRACT

A method for generating head-related, HR, filters is provided. The method comprises obtaining first body shape data that indicates a first shape of a first body part. The first shape of the first body part indicates a first size of a first body feature, BF. The method further comprises obtaining BF changing information that indicates how to change the first size of the first BF. The method further comprises changing the first size of the first BF in the first shape, thereby generating second body shape data that indicates a second shape of the first body part. The second shape of the first body part includes the first BF of a second size that is different from the first size. The method further comprises generating a set of HR filters associated with the second shape of the first body part.

### TECHNICAL FIELD

This disclosure relates to creating a large scale head-related (HR) filter database.

### BACKGROUND

The human auditory system is equipped with two ears that capture the sound waves propagating towards the listener. A sound wave propagating towards a listener from a direction of arrival (DoA) may be specified by a pair of an elevation angle and an azimuth angle in the spherical coordinate system. On the propagation path towards the listener, the sound wave interacts with the listener's upper torso, head, outer portions of ears, and the surrounding matter before reaching the listener's left and right ear drums. This interaction results in temporal and spectral changes of the sound waveforms reaching the left and right ear drums, some of which are DoA dependent. Our auditory system has learned to interpret these changes to infer various spatial characteristics of the sound wave as well as the acoustic environment in which the listener finds himself/herself.

This capability is called spatial hearing. The spatial hearing concerns inferring the location of an auditory event (e.g., sound emission by a physical audio source) and acoustic characteristics caused by a physical environment (e.g., small room, tiled bathroom, auditorium, cave, etc.) based on spatial cues embedded in a binaural signal (i.e., the sound signals in the right and the left ear canals). This human capability can in turn be exploited to create a spatial audio scene by reintroducing the spatial cues in the binaural signal that would lead to a spatial perception of a sound.

The main spatial cues include 1) angular-related cues: binaural cues (i.e., the interaural level difference (ILD) and the interaural time difference (ITD), and monaural (or spectral) cues); 2) distance-related cues: intensity and direct-to-reverberant (D/R) energy ratio. A mathematical representation of the short time DoA dependent temporal and spectral changes (1-5 msec) of the waveform is called HR filters. The frequency domain (FD) representations of the HR filters are called head-related transfer functions (HRTFs), and the time domain (TD) representations are the head-related impulse responses (HRIRs).

FIGS. 1A-1B and 1D-1E illustrate an example of ITD and spectral cues of a sound wave propagating towards a listener, and FIG. 1C shows a direction of a sound wave propagating towards the listener. The four plots shown in FIGS. 1A-1B and 1D-1E illustrate the time domain and the frequency domain responses of a pair of left and right HR filters obtained at an elevation of 0 degree and an azimuth of 40 degrees (Note that this data is from Center for Image Processing and Integrated Computing (CIPIC) database: subject-ID 28, which is provided in Reference [1]. The reference [1] is listed at the end of this disclosure. The database is publicly available and can be access from the link http://sofacoustics.org/data/database/cipic/).

An HR filter based binaural rendering approach has been gradually established. In the approach, a spatial audio scene is generated by directly filtering audio source signals with a pair of HR filters of desired locations. This approach is particularly attractive for many emerging applications such as virtual reality (VR), augmented reality (AR), mixed reality (MR), or extended reality (XR), and mobile communication systems, where headsets are commonly used.

The spatial cues embedded in the HR filters may be greatly influenced by the interaction of sound waves with the outer ears, head, and upper torso of a listener. Anthropometric features of the head of the listener (e.g., head width and head depth) are found to have significant effect on the binaural cues. Fine anthropometric features of outer ear, on the other hand, are found to have significant effect on the monaural cues. In this disclosure, anthropometric feature(s) of head is called “head feature(s),” and anthropometric feature(s) of ear(s) is called “ear feature(s).”

Examples of some anthropometric features (d1, d2, d3, d4, d5, d6, d7, d8, θ1, and θ2) of an ear is shown in FIG. 2. In FIG. 2, d1 is cavum concha height, d2 is cymba concha height, d3 is cavum concha width, d4 is fossa height, d5 is pinna height, d6 is pinna width, d7 is intertragal incisure width, d8 is cavum concha depth, θ1 is pinna rotation angle, and θ2 is pinna flare angle. Anthropometric differences in outer ears, head, and upper torso among different individuals may result in variations in the spatial cues among individuals. Therefore, each individual may experience sound in the real-world slightly differently.

Rendering a spatial audio scene that matches with one's real-world audio experience may require personal HR filters. The personal HR filters can be obtained directly by acoustic measurements on an individual, where the filters are often estimated as the impulse response of a linear invariant system that transforms the original sound signal (input signal) into the left and right ear signals (output signals) that can be measured inside the ear channels of a listening subject at a predefined set of elevation and azimuth angles on a spherical surface of constant radius from the individual under test. The measurement is usually performed in a dedicated audio lab, e.g., an anechoic chamber, which is very expensive to build. Moreover, it is a greatly time-consuming and complicated procedure. Due to the cost and the time-consuming and complicated procedure of the acoustic measurement approach, this approach is impractical for a large-scale deployment or a consumer-level applications.

Another approach for obtaining a personal HR filter set is through numerical simulation of HR filters using Boundary Element Method (BEM) described in Reference [2]. The reference [2] is listed at the end of this disclosure. Given a 3D mesh of ear, head, and/or upper torso of a person, this approach evaluates an HR filter set by simulating the sound-field scattered by human's outer ears, head, and torso. The BEM simulation method requires a fine-grained mesh of the outer ears in calculating HR filters for the full audible frequency range.

### SUMMARY

However, obtaining such fine-grained meshes of individuals' body parts via three-dimensional (3D) capturing is cumbersome. For example, the 3D capturing of the body parts may require using advanced 3D capturing devices and advanced procedures. In another example, during the 3D capturing, safety measures need to be taken to protect the individuals from radiation.

Thus, instead of obtaining the fine-grained meshes using the 3D capturing devices, some attempts have been made to create a large number of fine-grained 3D meshes by deforming or editing existing small number of base 3D meshes that were acquired by the 3D capturing devices. In this 3D mesh deformation approach, only a small number of 3D meshes (“base 3D meshes”) are obtained using the 3D capturing devices and a remaining large number of 3D meshes are obtained by deforming the base 3D meshes. By generating a large number of 3D meshes, HR filter sets for a large number of human subjects can be obtained.

But certain problems presently exist for the existing 3D mesh deformation approach. One example of the problems can be found in the CHEDAR database (which can be accessed from the link—http://sofacoustics.org/data/database/chedar/) which includes 1253 sets of computed HR filters and their associated 3D meshes. In the CHEDAR database, all meshes are derived by deforming one 3D model of ear, head, and torso, where the deformations are controlled by a set of blendshapes. The blendshape approach used to generate the CHEDAR database allows achieving numerous pre-defined shapes and any number of combinations of in-between the base and the pre-defined shapes. However, in the blendshape approach, there is no control over how much deformation is done in the in-between meshes. Also, in the blendshape approach, every vertex position must be manually manipulated for deformation, which is labor-intensive, and thus, the scalability of this method is limited.

Another example of the problems can be found in the WIDESPREAD database which can be accessed from the link—https://www.sofacoustics.org/data/database/widespread. The database contains deformed ear meshes and corresponding computed pinna-related transfer function (PRTF) sets that are based on a proprietary dataset of 119 3D left-ear scans. In this database, the deformed ear meshes are generated from an ear shape model. The ear shape model is derived based on principal component analysis (PCA) using a dataset comprising 3D ear meshes of 119 subjects. The 3D ear meshes of the 119 subjects are modeled by 17176 vertices as a point cloud with each point position specified by Cartesian coordinates. Accordingly, the ear shape of each subject is represented by a vector of length 3*17176=54528. The PCA is carried out on the set of ear point clouds of 119 subjects, and results in a statistical ear shape model, which is a weighted linear combination of principal components (PCs). Each PC is a vector of length 54528. The weights of PCs are mutually statistically independent and follow normal distribution with zero mean and a certain variance, where the variance of the weight corresponds to how much variance of the input ear shape data is captured by the corresponding PC. The PCA model of ear shape is then used to generate an arbitrarily large number of samples representing different ear shapes. The generation process is as follows: 1) a set of PC weights are drawn independently according to their respective probability distribution; and 2) given the set of PC weights, a sample of ear shape is obtained by a sum of weighted PCs. This method can scale up, however, as known, the PCs explain only the variance in the input ear shape data of 119 subjects, and more importantly, the correlation between PCs and ear parameters is not fully clear. As a result, the modification of ear shape based on changing PCs results in changing ear parameters randomly, and thus there is no guarantee that the generated ear shape is meaningful.

In order to generate an HR filter database that acts as a good statistical representation of HR filters of real-world human subjects, it is important that the deformed 3D meshes of body parts have a real-world statistical underpinning.

Accordingly, in one aspect of the embodiments of this disclosure, there is provided a method for generating head-related, HR, filters. The method comprises obtaining first body shape data (e.g., base mesh [symbol] ⁽⁰⁾) that indicates a first shape of a first body part (e.g., ear, head, upper torso). The first shape of the first body part indicates a first size of a first body feature

$$( e . g . , {a}_{h}^{( 0 )} , {a}_{e}^{l ( 0 )} , {a}_{e}^{r ( 0 )} ) ,$$

BF, in the first shape. The method further comprises obtaining BF changing information (e.g., [symbol] _{D}^{(j)}) that indicates how to change the first size of the first BF. The method further comprises changing the first size of the first BF in the first shape, thereby generating second body shape data (e.g., [symbol] ^{(j)}) that indicates a second shape of the first body part, wherein the second shape of the first body part includes the first BF of a second size that is different from the first size. The method further comprises generating a set of HR filters associated with the second shape of the first body part.

In another aspect, there is provided a computer program comprising instructions which when executed by processing circuitry cause the processing circuitry to perform the method of at least one of the embodiments described above.

In another aspect, there is provided a carrier containing the computer program of the above embodiment, wherein the carrier is one of an electronic signal, an optical signal, a radio signal, and a computer readable storage medium.

In another aspect, there is provided an apparatus for generating head-related, HR, filters. The apparatus is configured to obtain first body shape data (e.g., base mesh [symbol] ⁽⁰⁾) that indicates a first shape of a first body part (e.g., ear, head, upper torso). The first shape of the first body parts indicates a first size of a first body feature

$$( e . g . , {a}_{h}^{( 0 )} , {a}_{e}^{l ( 0 )} , {a}_{e}^{r ( 0 )} ) ,$$

BF, in the first shape. The apparatus is further configured to obtain BF changing information (e.g., [symbol] _{D}^{(j)}) that indicates how to change the first size of the first BF. The apparatus is further configured to change the first size of the first BF in the first shape, thereby generating second body shape data (e.g., [symbol] ^{(j)}) that indicates a second shape of the first body part, wherein the second shape of the first body part includes the first BF of a second size that is different from the first size. The apparatus is further configured to generate a set of HR filters associated with the second shape of the first body part.

In another aspect, there is provided an apparatus. The apparatus comprises a memory and processing circuitry coupled to the memory, wherein the apparatus is configured to perform the method of at least one of the embodiments described above.

Some embodiments of this disclosure allow creating a large number of 3D meshes of ear, head, and/or torso having meaningful anthropometric features with low cost, thereby allowing to generate a large-scale HR filter database that acts as a good statistical representation of HR filters of real-world human subjects. More specifically, in some embodiments, 3D base mesh(s) obtained using 3D capturing device(s) may be deformed in a way such that the resulting deformed 3D meshes are good statistical representations of 3D meshes of real-world human subjects.

### BRIEF DESCRIPTION OF THE DRAWINGS

The accompanying drawings, which are incorporated herein and form part of the specification, illustrate various embodiments.

FIGS. 1A, 1B, 1D, and 1E show time domain and frequency domain responses of a pair of HR filters.

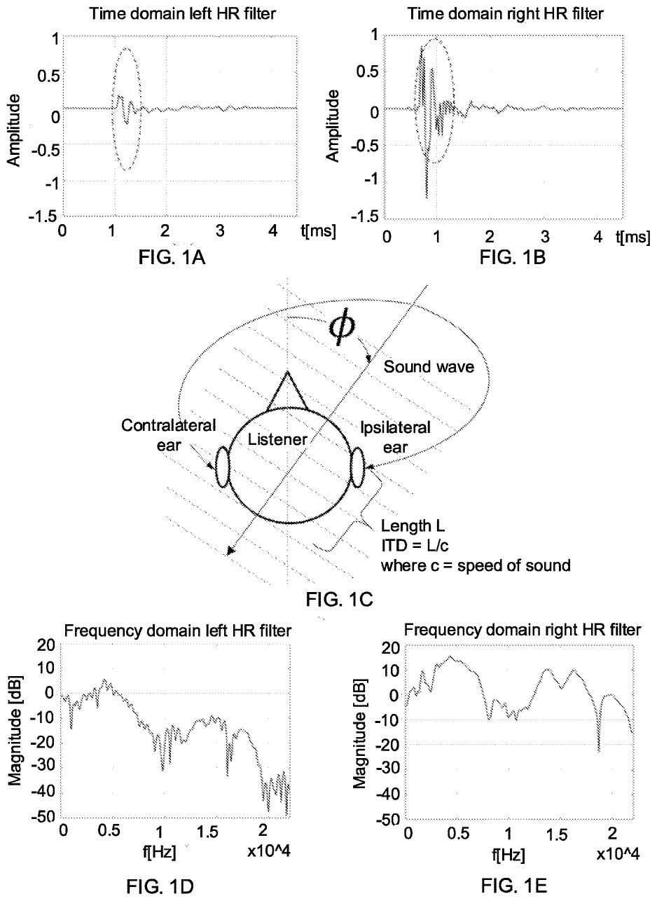

FIG. 1C shows a sound wave propagating towards a listener.

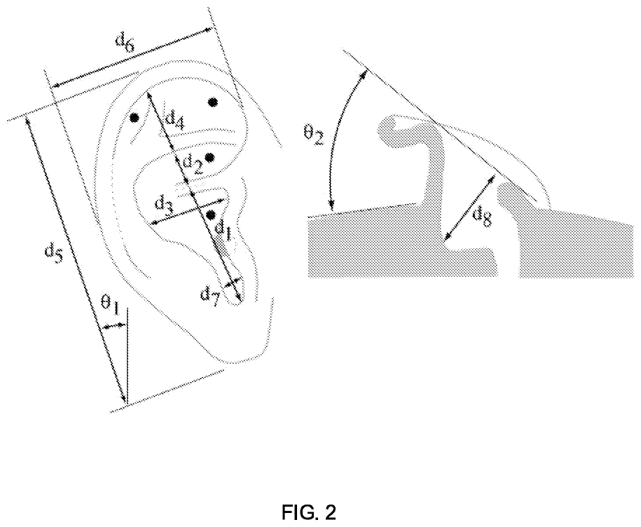

FIG. 2 shows examples of anthropometric measurements of an ear.

FIG. 3 shows a system according to some embodiments.

FIGS. 4A, 4B, 5A, and 5B illustrate the concept of an HR filter.

FIG. 6 shows a direction of arrival of an audio wave as observed from the listener, within a three-dimensional (3D) space.

FIG. 7 shows a set of HR filters located on a 2D sphere.

FIGS. 8(a) and 8(b) show examples of reflections of sound waves.

FIG. 9 shows a process according to some embodiments.

FIG. 10 shows an example of a 3D base mesh model.

FIG. 11 shows a process according to some embodiments.

FIG. 12 shows an apparatus according to some embodiments.

### DETAILED DESCRIPTION

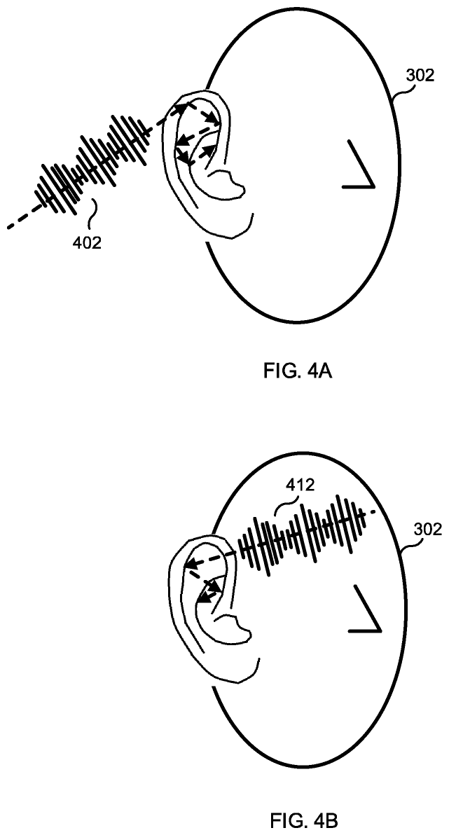

FIG. 3 shows an exemplary system 300 according to some embodiments. System 300 comprises a headphone 306, an audio rendering unit 312, and a server 314. Server 314 is configured to transmit audio data 316 to audio rendering unit 312 via network 310. Network 310 may be a wired network or a wireless network. Network 310 may be a cloud via which audio data 316 is transmitted from server 314 to audio rendering unit 312. In this disclosure, audio data is defined as data used for, after rendering (e.g., processing with HR filter(s)), providing a listener with an audio experience as if the listener is in a three-dimensional (3D) space where the audio source(s) are located. The audio data includes audio samples of source signals corresponding to audio source(s). In some embodiments, the audio data may additionally include HR filter information (e.g., an HR filter dataset) indicating HR filters.

After receiving audio data 316, audio rendering unit 312 may generate binaural audio signals and transmit the generated audio signals to headphone 306. Headphone 306 is configured to generate audio based on the audio signals, thereby providing user 302 with spatial audio experience. In some embodiments, instead of headphone 306, other audio generating devices such as an array of speakers may be used. The number of the speakers in the array can be any number larger than two.

In some embodiments, system 300 may additionally comprise an XR (such as VR, MR, AR, etc.) display headset 304. XR display headset 304 may be configured to generate different views of an XR environment based on the head orientation of user 302.

XR display headset 304 may be communicatively coupled to headphone 306. For example, XR display headset 304 may detect the head orientation of user 302, and based on the detected head orientation of user 302, display a different view of the XR environment. XR display headset 304 may also trigger audio rendering unit 312 to generate different audio signals corresponding to different views such that user 302 can hear different audio based on the head orientation of user 302.

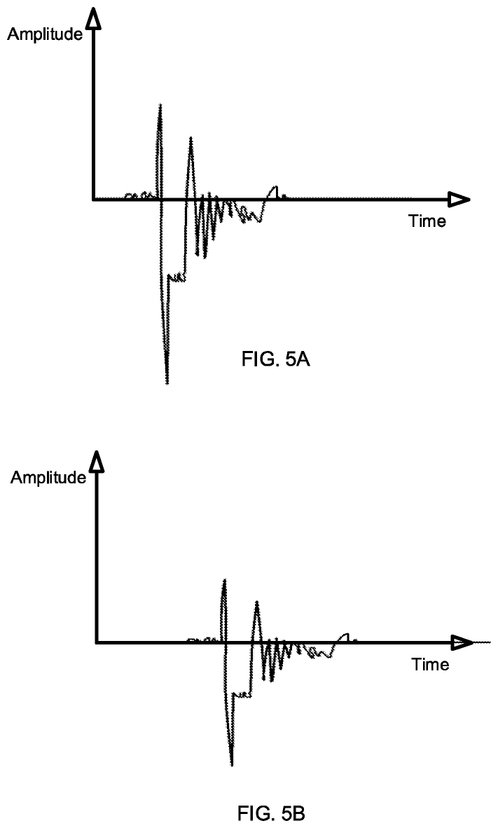

FIGS. 4A, 4B, 5A, and 5B illustrate the basic concept of HR filtering.

FIG. 4A shows an audio wave (a.k.a., sound wave) 402 propagating in a first direction and reaching the right ear of user 302, and FIG. 4B shows an audio wave 412 propagating in a second direction that is different from the first direction, and reaching the right ear of user 302. As shown in FIGS. 4A and 4B, depending on the DoA of the audio waves with respect to the center of user 302's head, the audio waves are diffracted and/or reflected in different ways (e.g., see the paths formed by the dotted arrows in FIGS. 4A and 4B). For simple explanation, only the reflections are shown in FIGS. 4A and 4B.

As explained above, HR filters are used for generating audio effects in which these different diffractions and reflections caused by different DoAs are factored. In other words, depending on the DoA of an audio wave, the audio wave goes through different temporal and spectral changes before being sensed by user 302, and a mathematical representation of such temporal and spectral changes is called an HR filter. Note that the reflection paths shown in FIGS. 4A and 4B are provided for illustration purpose only and may be different from actual reflection paths in a real world environment.

FIG. 5A shows an exemplary time domain response of a right HR filter for audio wave 402 and FIG. 5B shows an exemplary time domain response of a right HR filter for audio wave 412. As shown in the figures, because of the different temporal and spectral changes the audio waves go through, the waveforms (including the amplitude and the time of arrival (TOA) (or onset delay)) are different for audio waves 402 and 412. Note that the responses shown in FIGS. 5A and 5B are provided just to show few aspects of the impact of the HR filters, and thus may be different from the real responses.

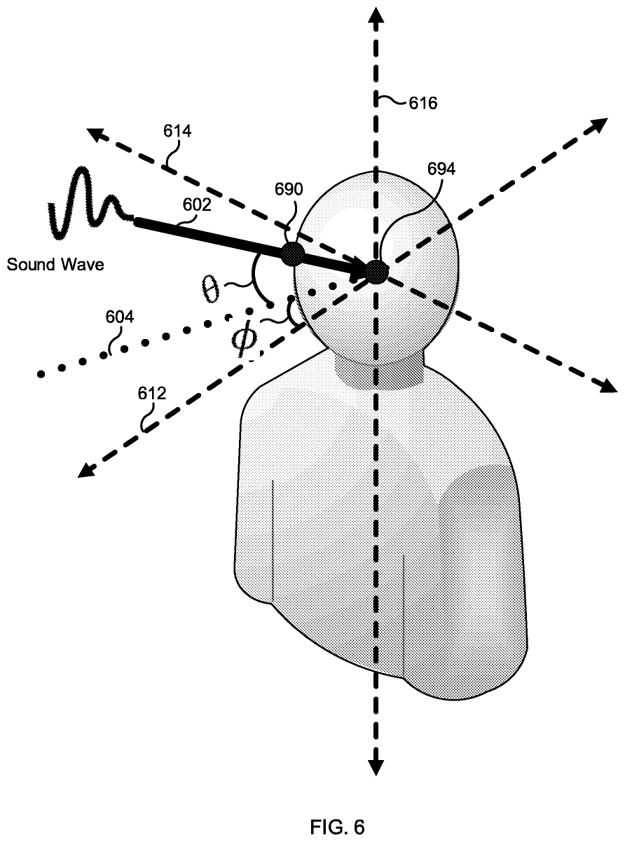

As discussed above, the temporal and spectral changes of an audio wave may vary depending on the DoA of the audio wave. In FIG. 6, a DoA vector 602 indicates the propagation direction of an audio wave within a 3D space defined by three axes 612, 614, and 616, where axes 612 is the front axes of the listener. DoA vector 602 may be defined using two angles—azimuth angle (φ) and elevation angle (θ). The azimuth angle (φ) is an angle between an axis 612 (e.g., an x-axis) and a projection vector 604 corresponding to a projection of DoA vector 602 onto a plane formed by axis 612 and an axis 614. The elevation angle (θ) is an angle between DoA vector 602 and projection vector 604.

Since the temporal and spectral changes of an audio wave may vary depending on the DoA which may be defined by the azimuth angle (φ) and the elevation angle (θ), in some embodiments, different HR filters (which represent such temporal and spectral changes) are provided for different combinations of the azimuth angle (@) and the elevation angle (θ).

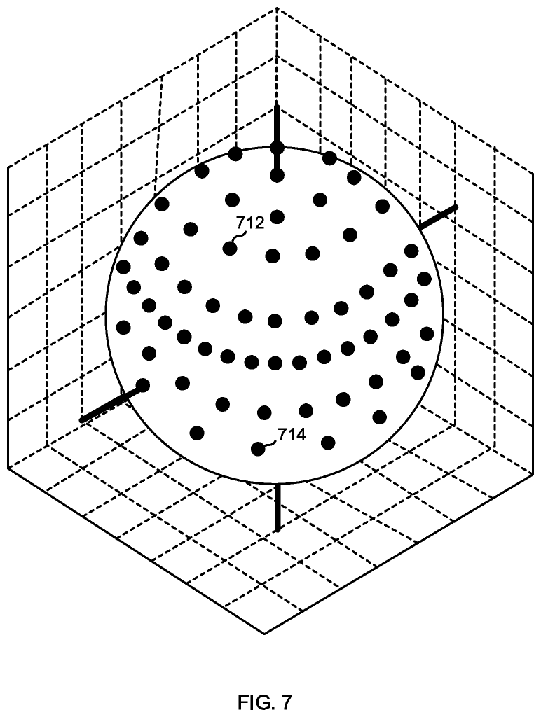

FIG. 7 shows exemplary sample locations (a.k.a., sample points) of a set of HR filters (a.k.a., an HR filter set) on a two-dimensional (2D) sphere surrounding user 302. As shown in FIG. 6, each sample point (e.g., 690) may be defined by a pair of an azimuth angle (φ) and an elevation angle (θ), and as discussed above, the azimuth angle is an angle between axis 612 and a projection (e.g., 604) of a line (e.g., 602) formed by a sample point (e.g., 690) and a center (e.g., 694) of the 2D sphere onto the plane formed by axis 612 and axis 614. The elevation angle is an angle between the line (e.g., 602) and the projection (e.g., 604). In some embodiments, the center of the 2D sphere may correspond to the center of the head of user 302.

The HR filter set may be used for generating audio depending on the head orientation of user 302. For example, an HR filter at a sample point 712 shown in FIG. 7 may be used for generating audio corresponding to a first combination (φ₁, θ₁) of an azimuth angle and an elevation angle, which corresponds to the audio wave's first DoA while an HR filter at a sample point 714 included in the HR filter set may be used for generating audio corresponding to a second combination (φ₂, θ₂) of an azimuth angle and an elevation angle, which corresponds to the audio wave's second DoA. By generating different audio using different HR filters corresponding to the different head orientations of user 302 and by providing such different audio to user 302, user 302 can perceive the spatial position of the audio source accurately.

Because different persons have different shapes and/or sizes of body parts (e.g., ear, head, torso, etc.) and because the same audio wave from the same audio source are diffracted and/or reflected differently based on the different shapes and/or sizes before reaching the ears of the different persons, it is desirable to provide different sets of HR filters for the different persons.

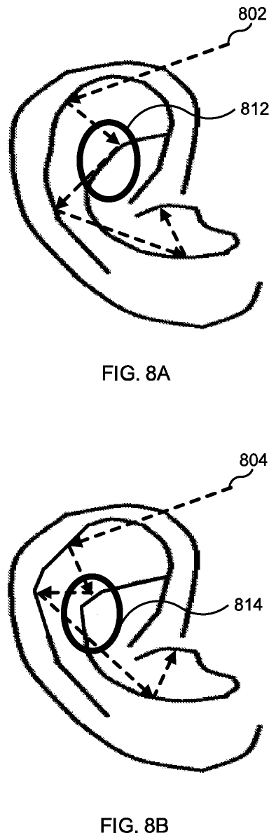

For example, in FIGS. 8A and 8B, even though audio waves 802 and 804 reach the ears of the listeners at the same angle, because the listeners' ears have different shapes (see the difference between the shapes of portions 812 and 814), the audio waves 802 and 804 are diffracted and/or reflected differently before reaching the ear drums of the listeners. In other words, even though the DoA of the audio waves 802 and 804 are the same, the audio waves go through different temporal and spectral changes before being sensed by the listeners. Thus, it is desirable to provide different HR filters for the same DoA for the listeners.

Thus, in some embodiments, different HR filter sets (for representing different temporal and spectral changes caused by different shapes of body parts) are generated using different 3D mesh shapes of a listener, and the different 3D mesh shapes are generated by deforming one or more 3D base meshes. More detailed explanation as to how the different 3D mesh shapes are generated is provided below.

### Data Variables and Notation

In this disclosure, general data structures are denoted as lists of data sequences and other data structures. A basic HR filter dataset [symbol] of a subject (e.g., the user 302) contains HR filters sampled at the M elevation and azimuth angles {(θ[m], φ[m]): m=1, . . . , M}, where θ and φ are respectively the elevation and azimuth angles and m denotes the index. The basic HR filter dataset [symbol] may be provided in the form of the data list [symbol] ={θ, φ, H^{l}, H^{τ}, a, [symbol] }. Even though the HR filter dataset [symbol] may also contain additional information such as ITD and/or onset delay information, such additional information is omitted for simple explanation purpose.

θ={θ[m]: m=1, . . . , M} denotes a sequence of elevation angles.

φ={φ[m]: m=1, . . . , M} denotes a sequence of azimuth angles.

H^{l}={h^{l}[m]: m=1, . . . , M} denotes a set of left HR filters,

where h^{l}[m]=h^{l}[1;m] . . . , h^{l}[n;m], . . . , h^{l}[N^{l};m] is an FIR filter of length N^{l}, and n is an index of the filter tap at a time instant. H^{r}={h^{r}[m]: m=1, . . . , M} denotes a set of right HR filters, where h^{r}[m]=[h^{r}[1;m] . . . , h^{r}[n;m], . . . , h^{r}[N′;m]] is an FIR filter of length N^{r}. Typically, the length of the left and the right filters are the same, N^{l}=N^{r}.

a denotes a set of A anthropometric features.

[symbol] denotes a 3D polygonal mesh model representing ears, head, and/or torso (e.g., upper torso) of a human subject. In some embodiments, a vertex-face representation may be used for [symbol] , where [symbol] ={V, F}.

V={vₓ, v_{y}, v_{z}} describes geometric positions of the vertices of the 3D mesh in [symbol] ³, where vₓ=[vₓ[1], . . . , vₓ[i], . . . , vₓ[I]] contains the x-coordinates of the vertices, v_{y}= [v_{y}[1], . . . , v_{y}[i], . . . , v_{y}[I]] contains the y-coordinates of the vertices, v_{z}=[v_{z}[1], . . . , v_{z}[i], . . . , v_{z}[I] contains the z-coordinates of the vertices, and I is the total number of vertices.

F={fₚ: p=1, . . . , P} describes the connectivity indicting how the P-gon faces of the 3D mesh are constructed from the vertices, where fₚ=fₚ[1], . . . , fₚ[q], . . . , fₚ[Q]], fₚ[q] is the index of a vertex that forms the p-th side of the q-th face, Q is the total number of faces, and P is the number of sides of a face.

[symbol] is a set of landmarks provided in the form of data list of vertices and physical measurements. [symbol] ={V_{L}, [symbol] }, where V_{L}={v_{Lx}[I], v_{Ly}[I], V_{Lz}[I]: l=1, . . . , L} describes the x-, y-, and z-coordinates of the vertices of the landmarks, L is the total number of landmarks, [symbol] is a vector of length A describing the physical measurements of anthropometric features, and A is the number of anthropometric features.

To simplify notation, in this disclosure, the sub- and/or superscripts may be omitted when they are not specifically needed.

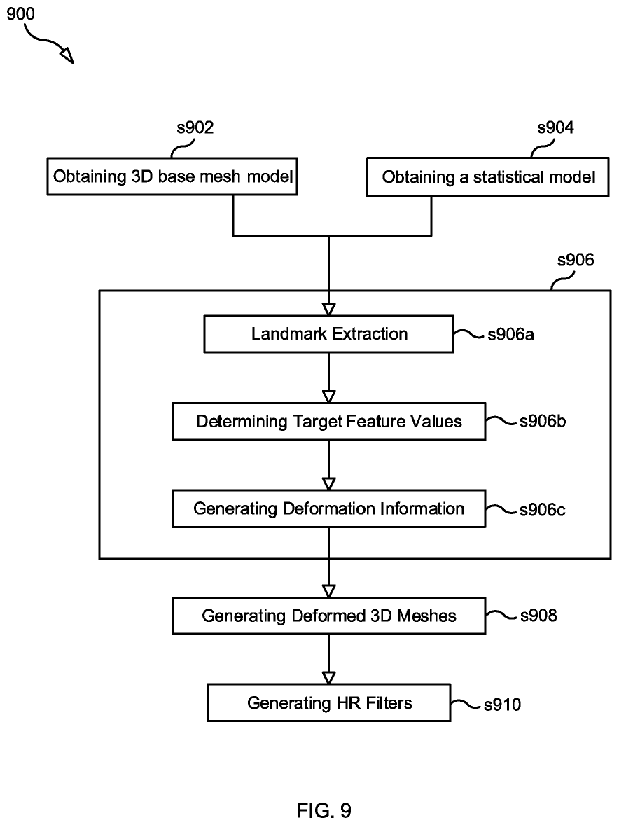

FIG. 9 shows a process 900 for creating a large scale database of HR filters, according to some embodiments. The process 900 may begin with step s902.

Obtaining 3D Base Mesh Model [symbol] ⁽⁰⁾

The step s902 comprises obtaining base body shape data that indicates a base body shape of a human subject. The shape is called a base shape because a plurality of deformed shapes is derived from this shape. The base body shape data may be obtained by capturing body parts of a human subject using one or more 3D capturing devices (e.g., camera(s)).

In some embodiments, the base body shape data may indicate a 3D base mesh model (denoted by [symbol] ⁽⁰⁾. For simple explanation purpose, in the rest of this disclosure, the base body shape data will be referred as 3D base mesh model, and the base body shape will be referred as the 3D base mesh even though they are merely examples of the base body shape data and the base body shape.

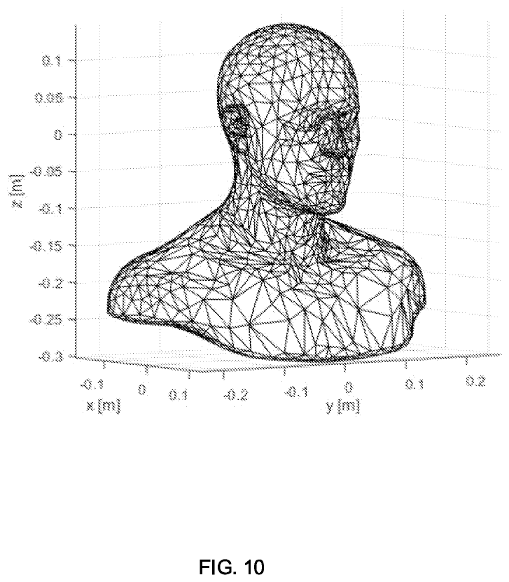

FIG. 10 shows an example of the 3D base mesh model. As shown in FIG. 10, the 3D base mesh model may be a polygon mesh having a vertex-face representation. In FIG. 10, the 3D base mesh model represents ears, head, and torso of a human subject. But, in other embodiments, the 3D base mesh model may only represent ears and head. In some embodiments, the 3D base mesh model may have a high-resolution, especially in the region of the ears, so that HR filters can be calculated for the full audible frequency range. To calculate the values of an HR filter at high frequencies, the mesh needs to have a higher resolution. The typical requirement of mesh resolution is to have six elements per wavelength. For example, because the speed of sound is around 343 m/s in the air at the room temperature and at the atmospheric pressure, and the wavelength of the sound frequency at 20 kHz is around 17 mm, the length of the edge of the mesh element should be smaller than 17/6 mm. Thus, a mesh element with edge length of 2 mm sufficiently captures the details of the pinna geometry for simulating HR filters up to 20 kHz.”

### Obtaining Statistical Model P

The process 900 may also comprise step s904. The step s904 may be performed before or after performing the step s902. Alternatively, the step s902 and s904 may be performed simultaneously. The step s904 comprises obtaining distribution data. One example of the distribution data is a statistical model. For simple explanation purpose, in the rest of this disclosure, the distribution data will be referred as the statistical model [symbol] even though the statistical model [symbol] is merely an example of the distribution data.

The statistical model [symbol] may (i) identify a group of one or more anthropometric features of each of one or more body parts and (ii) indicate a distribution of different sizes of each anthropometric feature included in the group. Table 1 provided below shows what the statistical model [symbol] indicates.

TABLE 1

| | | Ear Feature #1 | | |
|---|---|---|---|---|
| | | Size #1 | Size #2 | Size #3 |
| Head Feature #1 | Size #3 | 0.92 | 0.73 | 0.56 |
| | Size #4 | 0.32 | 0.84 | 0.65 |
| | Size #5 | 0.54 | 0.69 | 0.76 |

In the table provided above, the statistical model [symbol] identifies two anthropometric features—Ear Feature #1 and Head Feature #1. Each number included in the table indicates a joint probability of having a certain size of the ear feature and a certain size of the head feature or a conditional probability of having a certain size of the ear feature given a certain size of the head feature.

For example, 0.92 in the table may indicate a joint probability of having size #1 of the ear feature #1 and size #3 of the head feature #1 in a human subject. Similarly, 0.73 in the table may indicate a joint probability of having size #2 of the ear feature #1 and size #1 of the head feature #1 in a human subject.

In another example, 0.92 in the table may indicate a conditional probability of having size #1 of the ear feature #1 given size #3 of the head feature #1 in a human subject. Similarly, 0.73 in the table may indicate a conditional probability of having size #2 of the ear feature #1 given size #1 of the head feature #1 in a human subject. In other words, in this example, the statistical model may describe a conditional distribution of ear features given head features. As further explained below, this statistical model may be used to generate realistic samples of ear features given the head features of the 3D base mesh.

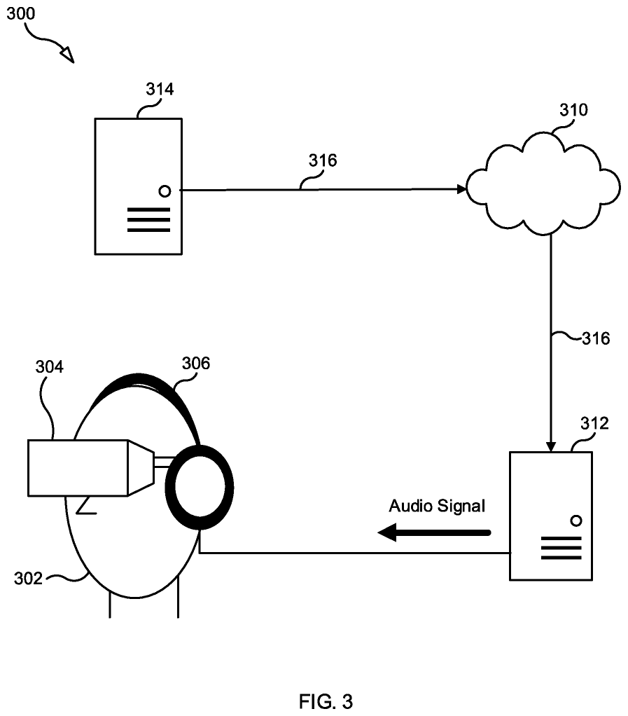

In some embodiments, the statistical model [symbol] may be denoted as a statistical model [symbol] (aₑ|aₕ) describing a conditional distribution of Aₑ-dimensional ear features aₑ given Aₕ-dimensional head features aₕ. Note that examples of the ear features include all or some of the features shown in FIG. 2, and examples of the head features include head width, head depth, head height, and/or so on.

An example of this model assuming a Gaussian distribution may be denoted as [symbol] (aₑ|aₕ)~ [symbol] (μ_{e|h}, Σ_{e|h}) with conditional mean

$${μ}_{e \vert h} = {μ}_{e} + {\sum }_{eh} {\sum }_{hh}^{- 1} ( {α}_{h} - {μ}_{h} )$$

and conditional covariance matrix

$${\sum }_{e \vert h} = {\sum }_{ee} - {\sum }_{eh} {\sum }_{hh}^{- 1} {\sum }_{he} .$$

μ_{e|h} is an Aₑ-dimensional mean vector of ear features conditioned on head features. μₑ is an Aₑ-dimensional mean vector of ear features. μₕ is a Aₕ-dimensional mean vector of head features. Σₑₕ is an Aₑ-by-Aₕ covariance matrix between ear features and head features. Σₕₑ is an Aₕ-by-Aₑ covariance matrix between head features and ear features. Σₑₑ is an Aₑ-by-Aₑ covariance matrix of ear features. Σₕₕ is an Aₕ-by-Aₕ covariance matrix of head features.

Even though the table 1 provided above shows only two anthropometric features (i.e., the ear feature #1 and the head feature #1) associated with two body parts (i.e., the ear and head), the number of anthropometric features and/or the number of body parts indicated in the statistical model is not limited to two. Each of them can be any number. Thus, even though the table provided above shows a joint/conditional probability of two anthropometric features, the statistical model may indicate a joint/conditional probability of more than two anthropometric features. Also, in some embodiments, the joint/conditional probability indicated in the statistical model may be between different sets of a plurality of anthropometric features, not between different anthropometric features.

For example, as shown in Table 2 provided below, a conditional probability indicated by the statistical model may be a conditional probability to have (i) the ear feature #1 having the size #1, (ii) the ear feature #2 having the size #2, and (iii) the ear feature #3 having the size #3, given (i) the head feature #1 having the size #3, (ii) the head feature #2 having the size #4, and (iii) the head feature #3 having the size #5.

TABLE 2

| | Ear Feature | Ear Feature | Ear Feature |
|---|---|---|---|
| | #1 - Size #1 | #2 - Size #2 | #3 - Size #3 |
| Head Feature #1 - Size #3 | 0.92 | | |
| Head Feature #2 - Size #4 | | | |
| Head Feature #3 - Size #5 | | | |

As further explained below, the statistical model obtained in step s904 may be used to generate realistic samples of anthropometric features for mesh deformation so that the deformed meshes represent real-world human subjects.

### Generating Deformation Information (the Specification for Deformation)

After obtaining the 3D base mesh model [symbol] ⁽⁰⁾ in step s902 and the statistical model [symbol] in step s904, the process 900 may proceed to step s906. The step s906 comprises obtaining deformation information (a.k.a., “body feature changing information” or “BF changing information”) that indicates how to deform (i.e., change) the 3D base mesh, thereby generating a plurality of deformed meshes. Each of the plurality of deformed meshes is a deformed version of the 3D base mesh. More specifically, each of the plurality of deformed meshes may be obtained by changing the size(s) of one or more anthropometric features of the 3D base mesh. Table 3 provided below shows simplified examples of the deformation used for generating a plurality of deformed meshes from the 3D base mesh shown in FIG. 2.

| | Type of Deformation | Result of Deformation |
|---|---|---|
| 3D Base Mesh | Changing d1 by a1 amount | Deformed Mesh #1 |
| | Changing d1 by a2 amount | Deformed Mesh #2 |
| | and d2 by b1 amount | |
| | Changing d2 by b1 amount | Deformed Mesh #3 |
| | Changing d1 by a1 amount, | Deformed Mesh #4 |
| | d2 by b1 amount, | |
| | d3 by c1 amount | |

The step s906 may comprise sub-steps 906a, 906b, and 906c.

### Generating Deformation Information—Sub-Step 1: Landmark Extraction

In the sub-step s906a, landmark is extracted from the 3D base mesh. In this disclosure, landmark is a set of anthropometric features of the 3D base mesh, which are to be updated in order to obtain the plurality of deformed meshes. The landmark of the 3D base mesh may be defined in the form of a data list of vertices and feature values. For example, the landmark of the 3D base mesh

$${ℒ}^{( 0 )} = \{ {V}_{L}^{( 0 )} , {α}_{h}^{( 0 )} , {α}_{e}^{1 ( 0 )} , {α}_{e}^{r ( 0 )} \} .$$

### Here,

$${α}_{h}^{( 0 )}$$

is a set (e.g., a vector) of size(s) of one or more head features of the 3D base mesh,

$${α}_{e}^{l ( 0 )}$$

is a set (e.g., a vector) of size(s) of one or more left ear features, and

$${a}_{e}^{r ( 0 )}$$

is a set (e.g., a vector) of size(s) of one or more right ear features.

$${V}_{L}^{( 0 )}$$

is a set of original coordinates of vertices of all landmarks (e.g., head, ear, and/or torso features). Among these vertices, those vertices corresponding to the ear features may be used as manipulation handles in the mesh deformation.

In some embodiments, there may be provided specification indicating how to perform the landmark extraction. Such landmark extraction specification may identify (i) a list of anthropometric features defining the landmark, and (ii) certain rules and/or parameters needed for performing the landmark extraction. In one example, the landmark extraction specification may be denoted by [symbol] _{LE}={ [symbol] _{L}} where:

L is a list of anthropometric features that define the landmark. The list of anthropometric features may be obtained from the statistical model [symbol] . For example, based on the distribution of various sizes of anthropometric features of human subjects indicated by the statistical model [symbol] , a set of anthropometric features that are worthwhile may be identified. The list may include a set of one or more ear features to be deformed and a set of one or more head features required by the model [symbol] for generating J sets of target ear feature values. Here, the deformed meshes may be obtained by changing the ear features values of the 3D base mesh to be the target ear feature values.

[symbol] _{L} describes the rules and/or parameters needed for landmark extraction corresponding to the specified anthropometric features L. For each anthropometric feature, the following parameters may be specified:
[symbol] specifies the view of a two-dimensional (2D) outline to be extracted (e.g., front view or side view).
Δ specifies a resolution of the outline points (e.g., 0.75E-03 meters for head features and 0.25E-03 meters for ear features).
ξ specifies search ranges of landmarks.

There are various ways of performing the landmark extraction. For example, in some embodiments, a method described in Reference [3] (which is hereby incorporated by reference) may be used for performing the landmark extraction. The reference [3] is listed at the end of this disclosure.

### Generating Deformation Information—Sub-Step 2: Determining Target Feature Values

The sub-step 906b comprises determining J sets of target values of ear feature(s)

$$\{ {a}_{e}^{( j )} : j = 1 , … , J \}$$

using the statistical model [symbol] given the head feature(s) of the 3D base mesh

$${a}_{h}^{( 0 )} .$$

As discussed above, the statistical model [symbol] indicates various values (i.e., sizes) of ear feature(s) associated with each of one or more head feature(s) (e.g., see the tables 1 and 2 provided above).

But if the values of the ear features

$${a}_{e}^{( 0 )}$$

are much different from the mean values of the distribution modeled by the statistical model [symbol] , drawing samples directly from [symbol] without restrictions likely results in many samples of ear features which are much different from

$${a}_{e}^{( 0 )} .$$

The following scenario illustrates an example of this problem. Let's assume that the 3D base mesh has only a single left ear feature having a value of 0.1

$$( meaning that {a}_{e}^{l ( 0 )} = 0.1 ) ,$$

a single right ear feature

$${a}_{e}^{( 0 )}$$

having a value of 0.2

$$( meaning that {a}_{e}^{r ( 0 )} = 0.2 ) ,$$

and a single head feature

$${a}_{h}^{( 0 )}$$

having a value of 0.5

$$( meaning that {a}_{h}^{( 0 )} = 0.5 ) .$$

Note that the values of the ear/head features are provided only for simple explanation purpose, and do not limit the embodiments of this disclosure in any way. Let's further assume that the statistical model [symbol] indicates that there are three values of the left ear feature—2.8, 2.9, and 2.6—that are associated with the value of the head value 0.5. Here, the mean value of the left ear feature is

$$\frac{2.8 + 2.9 + 2.3}{3} = 3 \text{.0} .$$

In this scenario, the value of the single left ear feature of the 3D base mesh (i.e., 0.1) is far from the mean value of the left ear feature (i.e., 3.0).

The large difference(s) between the values(s) of the original ear feature(s) (i.e., the value(s) of the ear feature(s) of the 3D base mesh) and the mean value(s) of the ear feature(s) provided by the statistical model [symbol] implies that the 3D base mesh will be deformed in a large degree, thereby resulting in unnatural looking ears. Moreover, a large degree of deformation may cause self-intersection problem during mesh editing process. A deformed mesh with self-intersecting elements needs to be either repaired or discarded.

Therefore, according to some embodiments, in order to avoid unnatural looking ears and the self-intersection problem during mesh deformation is to reduce the degree of deformation. That means that the generated ear features

$${a}_{e}^{( j )}$$

are limited to values which lie above or below a given threshold or within a specified range so that they are not too far from

$${a}_{e}^{( 0 )} .$$

Let T [symbol] (aₑ|aₕ, bₗ, bᵤ) denote a truncated model of [symbol] (aₑ|aₕ), where bₗ is the lower bound of aₑ and bᵤ is the upper bound of aₑ. From the truncated model, the generated ear features

$${a}_{e}^{( j )}$$

are bounded to have values within the range [bₗ,bᵤ]. Take Gaussian distribution as an example, the truncated model reads T [symbol] (aₑ|aₕ, bₗ, bᵤ)~ [symbol] (μ_{e|h}, Σ_{e|h}, bₗ, bᵤ). A deviation of 5% seems to be reasonable, that is,

$${b}_{1} = 0.95 * {a}_{e}^{( 0 )} and {b}_{u} = 1.05 * {a}_{e}^{( 0 )} .$$

Using T [symbol] (aₑ|aₕ, bₗ, bᵤ)~ [symbol] (μ_{e|h}, Σ_{e|h}, bₗ, bᵤ), the information from real world data is used to fit a general distribution for ear features given head features, and the samples from the portion of this distribution which lies as close to the initial mesh feature values are drawn. However, in practice though, it proved to be difficult or time consuming to sample from this distribution. For example, a rejection sampling method has very high time complexity due to a low acceptance rate for the samples. The reason for this is that if some of the initial mesh ear values lie far from the estimated conditional mean, then the truncation interval has a low probability mass, which means that a lot of samples are rejected.

An efficient solution, which also seemed quite natural, is to replace the conditional mean μ_{e|h} by the original ear feature values

$${a}_{e}^{( 0 )} .$$

The distribution to sample from becomes

$$𝒩 ( {a}_{e}^{( 0 )} , {\sum }_{e \vert h} , {b}_{1} , {b}_{u} ) .$$

When using this distribution, rejection sampling method seems to be an effective sampling strategy. As μ_{e|h} is replaced by

$${a}_{e}^{( 0 )} ,$$

this distribution does not fully capture the effect that the specific head features

$${a}_{h}^{( 0 )}$$

of the original mesh has on the conditional distribution, since this variable only appears when defining the conditional mean, which was replaced. It did however prove to be good enough to generate realistic looking meshes with some subtle variation in shape, which was the intended purpose of the model.

### Generating Deformation Information—Sub-Step 3: Calculating Control Parameters

The step s906c comprises calculating deformation information (a.k.a., “body feature changing information” or “BF changing information”) based on the target feature values obtained in the step s906b. The deformation information may be denoted as [symbol] _{D}^{(j)}, where [symbol] _{D}^{(j)} describes handles' control parameters for the target ear features

$${a}_{e}^{( j )} .$$

Note that a mesh deformation consists of manipulating handles with each being a set of vertices that can be moved, rotated, and scaled. The manipulation handles are a sub-set of landmarks that are extracted according to user specified landmark extraction rules, and the manipulation of the handles is controlled through user specified control rules. The manipulation of the handles induces a global deformation within the sub-mesh of the Region Of Interest (ROI). Given the full set of the landmarks, the ROI is extracted using a mesh segmentation technique according to user specified ROI extraction rules. The deformation is achieved by a mesh editing algorithm according to user specified deformation rules.

Referring back to step s906c, if the deformation is to be performed by changing the ear features d1, d2, and d3 shown in FIG. 2, the deformation information may indicate how to change the values of the ear features d1, d2, and d3 of the 3D base mesh to be the target values of the ear features d1, d2, and d3. More specifically, in one example, the deformation information may indicate Δd1, Δd2, and Δd3 where Δd1=d1^{(target)}−d1⁽⁰⁾, Δd2=d2^{(target)}−d2⁽⁰⁾, and Δd3=d3^{(target)}−d3⁽⁰⁾. Here, d1^{(target)}, d2^{(target)}, and d3^{(target)} are the target values of the ear features d1, d2, and d3, which are obtained in step s906b, and d1⁽⁰⁾, d2⁽⁰⁾, and d3⁽⁰⁾ are values of the ear features d1, d2, and d3 of the 3D base mesh.

In some embodiments, [symbol] _{D}^{(j)}=[ [symbol] _{D}, ρ^{l(j)}, ρ^{r(j)}] where:
[symbol] _{D}≤ [symbol] specifies anthropometric features to deform (i.e., ear features aₑ). In the above example, [symbol] _{D} identifies d1, d2, and d3.
ρ (specifies the level of deformation of each feature in L_{D}, e.g., the amount of enlargement or reduction in the size of each feature. The level of deformation of each feature may be calculated from the value of the target ear feature

$${a}_{e}^{( j )}$$

with respect to the original ear feature

$${a}_{e}^{( 0 )} ,$$

respectively. In the above example, Δd1, Δd2, and Δd3 corresponds to the level of deformation of each feature.

### Generating Deformed 3D Meshes

The step s908 comprises deforming the 3D base mesh, thereby generating a plurality of deformed 3D meshes. In order to generate a large number of 3D meshes with desired anthropometric features, in some embodiments, the rule-based method described in Reference [3] may be used. The 3D polygonal mesh deformation may be performed according to specifications of which anthropometric features represented in the 3D polygonal mesh are to be deformed and how those features are to be deformed.

Specifications to the rule-based 3D mesh deformation include the landmark extraction specification [symbol] _{LE}={ [symbol] _{L}}, the ROI extraction specification [symbol] _{RE}={ [symbol] _{S}, [symbol] _{C}}, and the deformation specification [symbol] _{ME}={ [symbol] _{D}, [symbol] _{D}, [symbol] }. The setting of the landmark extraction specification [symbol] _{LE} is discussed in Error! Reference source not found. Step 1 and the setting of the handles' control parameters [symbol] _{D} is discussed in Error! Reference source not found. Step 3. The setting for the rest specifications can be found in Reference [3].

Given the required specifications, the base mesh is deformed. Details on the method of the rule-based 3D mesh deformation refer to Reference [3].

The outputs of the mesh deformation are J meshes, { [symbol] ^{(j)}: j=1, . . . J}.

### Generating HR Filters

Step s910 comprises numerically calculating a set of HR filters [H^{l}, H^{r}]^{(j)} for each mesh [symbol] ^{(j)} included in the plurality of deformed meshes. For example, if three deformed meshes [symbol] ⁽¹⁾, [symbol] ⁽²⁾, and [symbol] ⁽³⁾ are obtained in the step s206, three sets of HR filters—[H^{l}, H^{r}]⁽¹⁾ [H^{l}, H^{r}]⁽²⁾, and [H^{l}, H^{r}]⁽³⁾—may be obtained in the step s208. The set of HR filters may be calculated on a pre-defined grid specified by (θ, φ) over a 2D sphere of fixed radius (e.g., see FIG. 7) at a specified sample rate. Here, the sample rate indicates a density of the set of HR filters on the pre-defined grid.

As discussed above, the BEM method is a well-established method for numerical simulation of HR filters given a polygon surface mesh. One example of the BEM method is explained in [2], which is hereby incorporated by reference. An open-source software, MESH2HRTF, provides an easy-to-use software package for the numerical calculation of HR filters. It can be accessed via https://github.com/Any2HRTF/Mesh2HRTF/releases.

The process of generating HR filters according to some embodiments can be summarized as follows: First, the 3D base mesh indicating a base 3D shape is obtained. Then, a distribution of 3D shapes of various human subjects is obtained. Based on the 3D shape distribution, the 3D base mesh is deformed into various deformed 3D meshes. After obtaining the deformed 3D meshes, a set of HR filters associated with each of the deformed 3D meshes is obtained.

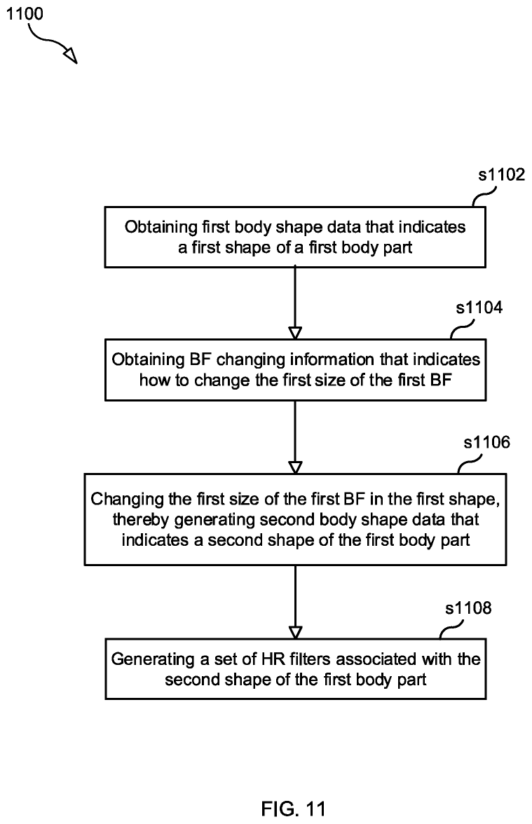

FIG. 11 shows a process 1100 for generating head-related, HR, filters. The process 1100 may begin with step s1102. The step s1102 comprises obtaining first body shape data (e.g., base mesh [symbol] ⁽⁰⁾) that indicates a first shape of a first body part (e.g., ear, head, upper torso). The first shape of the first body part indicates a first size of a first body feature

$$( e . g . , {a}_{h}^{( 0 )} , {a}_{e}^{1 ( 0 )} , {a}_{e}^{r ( 0 )} ) ,$$

BF, in the first shape. Step s1104 comprises obtaining BF changing information (e.g., [symbol] _{D}^{(j)}) that indicates how to change the first size of the first BF. Step s1106 comprises changing the first size of the first BF in the first shape, thereby generating second body shape data (e.g., [symbol] ^{(j)}) that indicates a second shape of the first body part, wherein the second shape of the first body part includes the first BF of a second size that is different from the first size. Step s1108 comprises generating a set of HR filters associated with the second shape of the first body part.

In some embodiments, the first size of the first BF in the first shape is determined using the first body shape data

In some embodiments, the process 1100 comprises obtaining distribution data (e.g., the statistical model [symbol] ) that (i) identifies a first group of BFs associated with the first body part and (ii) indicates a distribution of different sizes of each BF included in the first group of BFs; and determining a size of each BF of the first group of BFs in the first shape, wherein the first BF is included in the first group of BFs.

In some embodiments, the distribution data (i) identifies a second group of BFs associated with a second body part, and (ii) indicates a distribution of different sizes of each BF included in the second group of BFs, and the first body part and the second body part are different.

In some embodiments, each of the first body part and the second body part is selected from a group consisting of ear, head, and torso.

In some embodiments, the distribution data indicates the distribution of the different sizes of each BF included in the first group of BFs given the distribution of the different sizes of one or more BFs included in the second group of BFs.

In some embodiments, the distribution data indicates a variation in the size of the first BF with respect to a size of another BF included in the second group of BFs or a variation in the size of said another BF in the second group of BFs.

In some embodiments, the process 1100 comprises generating a set of different sizes of the first BF using the distribution data, wherein the set of different sizes includes the second size.

In some embodiments, the BF changing information is generated based on the set of different sizes of the first BF and the first size of the first BF.

In some embodiments, a difference between the first size of the first BF and the second size of the first BF is less than a threshold value.

In some embodiments, the threshold value is determined based on a value of the first BF.

In some embodiments,

$$\vert {a}_{e}^{( 0 )} - {a}_{e}^{( j )} \vert \leq b$$

where

$${a}_{e}^{( 0 )}$$

is the first size,

$${a}_{e}^{( j )}$$

is the second size, and b is the threshold value.

In some embodiments, the process 1100 comprises based on the first shape, determining coordinates of vertices of the first BF in the first shape, wherein generating the second body shape data comprises changing one or more of the coordinates of the vertices of the first BF.

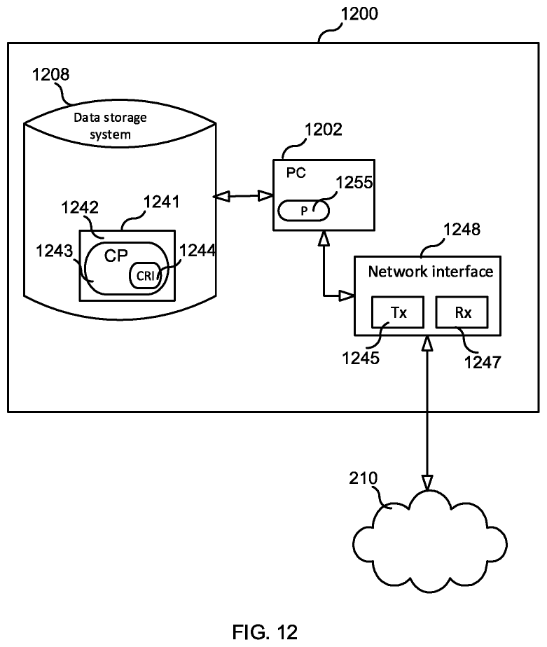

FIG. 12 is a block diagram of an apparatus 1200, according to some embodiments, for performing the methods described above (e.g., process 1200 shown in FIG. 12). Apparatus 1200 may be included in any one or more of: server 214, audio rendering unit 212, or headphone 206. As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248, each network interface 1248 comprises a transmitter (Tx) 1245 and a receiver (Rx) 1247 for enabling apparatus 1200 to transmit data to and receive data from other nodes connected to a network 210 (e.g., an Internet Protocol (IP) network) to which network interface 1248 is connected (directly or indirectly) (e.g., network interface 1248 may be wirelessly connected to the network 210, in which case network interface 1248 is connected to an antenna arrangement); and one or more storage units (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCE LIST

[1] V. R. Algazi, R. O. Duda, D. M. Thompson and C. Avendano, “The CIPIC HRTF Database,” in IEEE Workshop on Applications of Signal Processing to Audio and Electroacoustics, Mohonk Mountain House, New Paltz, NY, 2001.
[2] W. Kreuzer, P. Majdak and Z. Chen, “Fast multipole boundary element method to calculate head-related transfer functions for a wide frequency range,” The Journal of the Acoustical Society of America, vol. 126, no. 3, pp. 1280-1290, 2009.
[3] I. Athanasiadis, M. Zhang and E. Karlsson, “3D Polygonal Mesh Deformation”. Greece

1. A method for generating head-related (HR) filters, the method comprising:
obtaining first body shape data that indicates a first shape of a first body part, wherein the first shape of the first body part indicates a first size of a first body feature, BF;
obtaining BF changing information that indicates how to change the first size of the first BF;
changing the first size of the first BF in the first shape, thereby generating second body shape data that indicates a second shape of the first body part, wherein the second shape of the first body part includes the first BF of a second size that is different from the first size; and
generating a set of HR filters associated with the second shape of the first body part.

2. The method of claim 1, wherein
the first size of the first BF in the first shape is determined using the first body shape data.

3. The method of claim 1, wherein
the method further comprises:
obtaining distribution data that (i) identifies a first group of BFs associated with the first body part and (ii) indicates a distribution of different sizes of each BF included in the first group of BFs; and
determining a size of each BF of the first group of BFs in the first shape, and
the first BF is included in the first group of BFs.

4. The method of claim 3, wherein
the distribution data (i) identifies a second group of BFs associated with a second body part, and (ii) indicates a distribution of different sizes of each BF included in the second group of BFs, and
the first body part and the second body part are different.

5. The method of claim 4, wherein
each of the first body part and the second body part is selected from a group consisting of ear, head, and torso.

6. The method of claim 4, wherein
the distribution data indicates the distribution of the different sizes of each BF included in the first group of BFs given the distribution of the different sizes of one or more BFs included in the second group of BFs.

7. The method of claim 6, wherein
the distribution data indicates a variation in the size of the first BF with respect to a size of another BF included in the second group of BFs or a variation in the size of said another BF in the second group of BFs.

8. The method of claim 3, wherein
the method further comprises generating a set of different sizes of the first BF using the distribution data, and
the set of different sizes includes the second size.

9. The method of claim 8, wherein
the BF changing information is generated based on the set of different sizes of the first BF and the first size of the first BF.

10. The method of claim 1, wherein
a difference between the first size of the first BF and the second size of the first BF is less than a threshold value.

11. The method of claim 10, wherein
the method further comprises:
obtaining distribution data that (i) identifies a first group of BFs associated with the first body part and (ii) indicates a distribution of different sizes of each BF included in the first group of BFs; and
determining a size of each BF of the first group of BFs in the first shape,
the first BF is included in the first group of BFs, and
the threshold value is determined based on a value of the first BF.

12. The method of claim 10, wherein
$$\vert {a}_{e}^{( 0 )} - {a}_{e}^{( j )} \vert \leq b$$
where
$${a}_{e}^{( 0 )}$$
is the first size,
$${a}_{e}^{( j )}$$
is the second size, and b is the threshold value.

13. The method of claim 1, wherein
the method further comprises, based on the first shape, determining coordinates of vertices of the first BF in the first shape, and
generating the second body shape data comprises changing one or more of the coordinates of the vertices of the first BF.

14. A non-transitory computer readable storage medium storing a computer program comprising instructions which when executed by processing circuitry cause the processing circuitry to perform the method of claim 1.

15-17. (canceled)

18. An apparatus comprising:
a memory; and
processing circuitry coupled to the memory, wherein the apparatus is configured to perform a method for generating head-related (HR) filters, the method comprising:
obtaining first body shape data that indicates a first shape of a first body part, wherein the first shape of the first body part indicates a first size of a first body feature, BF;
obtaining BF changing information that indicates how to change the first size of the first BF;
changing the first size of the first BF in the first shape, thereby generating second body shape data that indicates a second shape of the first body part, wherein the second shape of the first body part includes the first BF of a second size that is different from the first size; and
generating a set of HR filters associated with the second shape of the first body part.

19. The apparatus of claim 18, wherein the first size of the first BF in the first shape is determined using the first body shape data.

20. The apparatus of claim 18, wherein
the method further comprises:
obtaining distribution data that (i) identifies a first group of BFs associated with the first body part and (ii) indicates a distribution of different sizes of each BF included in the first group of BFs; and
determining a size of each BF of the first group of BFs in the first shape, and
the first BF is included in the first group of BFS.

21. The apparatus of claim 20, wherein
the distribution data (i) identifies a second group of BFs associated with a second body part, and (ii) indicates a distribution of different sizes of each BF included in the second group of BFs, and
the first body part and the second body part are different.

22. The apparatus of claim 21, wherein each of the first body part and the second body part is selected from a group consisting of ear, head, and torso.

23. The apparatus of claim 21, wherein
the distribution data indicates the distribution of the different sizes of each BF included in the first group of BFs given the distribution of the different sizes of one or more BFs included in the second group of BFs.
